(19) United States
(12) Patent Application Publication
(10) Pub. No.: US 2015/0031594 A1
(43) Pub. Date: Jan. 29, 2015

(54) OIL RECOVERY

(71) Applicant: OTI Greentech Group AG, Zug (CH)

(72) Inventor: Jawahar Lal Wakhloo, Saarbrucken (DE)

(21) Appl. No.: 14/384,670

(22) PCT Filed: Mar. 11, 2013
(86) PCT No.: PCT/EP2013/054910

§ 371 Date: Sep. 11, 2014

(30) Foreign Application Priority Data
Mar. 15, 2012 (CH) 00374/12

(51) Int. Cl. C11D 1/825; C11D 3/382; C11D 17/00; B09C 1/02

(52) U.S. Cl. CPC C11D 1/825; B09C 1/02; C11D 3/382; C11D 17/0008
USPC 510/365

(57) ABSTRACT

An aqueous cleaning solution for treating hydrocarbon-contaminated soil and for cleaning hydrocarbon-contaminated surfaces is provided. Suitably it is prepared by progressively diluting a concentrate comprising: i) 10-60% by volume of a first emulsifier; (ii) 10-60% by volume of a second emulsifier and (iii) 20-70% by volume of vegetable oil In a preferred embodiment the concentrate comprises a polyethylene glycol sorbitan trioleate, a polyoxyethylene sorbitan monopalmitate and corn oil with the two sorbitan molecules having different HLB-values.

The present invention relates to a cleaning solution for the removal of hydrocarbon contaminants from fouled surfaces; in particular to clean hydrocarbon residues, from tankers, tanks, pipelines and other equipment used in working with hydrocarbons. The cleaning solution is also useful for separating oil from solids, water and emulsions during oil production, and for decontaminating polluted soils, sands, beaches, rocks and the like.

One consequence of working with hydrocarbons on an industrial scale, whether in drilling for petroleum, the production of oil, the transportation of oil refinery and petrochemical products in ships, road and railcars or pipelines, or their storage prior to use, is the inevitable contamination of the associated equipment used. Furthermore, unintentional leakage during production and transport also brings with it the additional hazard of environmental pollution on both land and sea all over the world. Oil spills at sea can, in particular, lead to gross contamination of the seabed or can be washed ashore fouling the shoreline, killing wildlife and disrupting commerce.

In addition, recovery of oil from other materials produced in the oil production is often a pressing need especially where such recovered oil can be potentially used for economic benefit. However the methods currently employed are relatively expensive and poorly developed. This is especially so in the case of the treatment of polluted land where mechanical removal of the contaminated soil is frequently the only option; an operation which is both expensive and complex from a logistical perspective. Alternative chemical methods exist but they frequently suffer from the drawback that the chemical itself can be potentially harmful to the environment too. An example of this approach, which has been adopted in the oil industry, is the use of high pH cleaners containing significant amounts sodium hydroxide.

WO2007051337 discloses an environmentally friendly agent for treating oil-polluted ground, and for cleaning oil-contaminated surfaces and containers. It consists of a concentrate and a derived, water-diluted cleaning solution; the former comprising an emulsifier, a vegetable oil and an alcohol (preferably ethanol). The emulsifier is suitably a non-ionic surfactant with a Hydrophobic-Lipophilic balance (HLB) value between 7 and 8. A range of vegetable oils, including soya, palm, rape, sunflower, peanut, and cottonseed, in particular oils with an unsaturated fatty acidity such as corn, soya and cottonseed, are said to be particularly beneficial. In use, the three-component concentrate is first diluted with water to form a cleaning solution and then applied to, for example, the particular oil-contaminated surface that is to be treated. The oil becomes emulsified with the cleaning solution making it easier to detach from the surface and more easily biodegradable. A similar approach has been disclosed in WO2012140248 which involves the use of octanol as the alcohol.

EP474413 discloses a method for removing oil deposited on a shoreline using a mixture of two emulsifiers. However the compositions disclosed all contain non-polar paraffinic, isoparaffinic or naphthenic solvents rather than vegetable oils.

WO0036080 discloses an absorbent wipe impregnated with an oil-based cleaning solvent comprising d-limonene (an unsaturated hydrocarbon), a non-polar mineral oil and a hydrophilic surfactant. Not only are such wipes formulated for personal as opposed to industrial use but they do not appear to involve the use of vegetable oils either.

Finally, U.S. Pat. No. 5,780,407 and U.S. Pat. No. 5,634,984 together generically disclose a method for cleaning oil-contaminated substrates employing a composition composed of a diluent oil, a first emulsifier having a HLB value of at least 10, and a second emulsifier having a higher HLB value. The difference in the HLB values of the first and second emulsifier is at least 3 and a mixture of the emulsifiers should have a HLB value of at least 11. The diluent oil can be selected from a long list of both polar and non-polar oils including vegetable oils but no specific exemplification of vegetable oils in such fluids is provided nor is there any discussion of the resulting properties; rather the patent appears to be principally directed to diluents such as white mineral oil, diesel and terpenes such as d-limonene. The water content of the fluid should typically be less than 5 volume %, preferably significantly less than 1% and, most preferably of all, the fluid should be devoid of water.

We have now identified certain compositions containing vegetable oils and non-ionic surfactants which are especially efficacious for cleaning hydrocarbon contaminated surfaces when diluted with significant quantities of water. In particular, the compositions we disclose are such that when used for the cleaning duties discussed above in water diluted form they are not only effective but produce an easily separable two-phase effluent rather than a stable emulsion of the hydrocarbon contaminant in the cleaning fluid which requires significant further processing before it can be either reused or discharged to the environment with minimal further treatment. The compositions of the present invention on account of being alcohol free also have the advantage of a high flash point making them especially suitable for use in environments where there is a high risk of fire or explosion.

Thus, according to a first aspect of the present invention, there is provided a concentrate for manufacturing an aqueous cleaning solution for treating hydrocarbon-contaminated soil and/or for cleaning hydrocarbon-contaminated surfaces, comprising:
i) 10-60% by volume of a first emulsifier;
(ii) 10-60% by volume of a second emulsifier and
(iii) 20-70% by volume of vegetable oil.

Preferably, the concentrate comprises 20 to 50% by volume of the first emulsifier; 20 to 50% by volume of the second emulsifier and 30 to 60% by volume of the vegetable oil (all on a vol/vol basis). More preferably, the concentrate comprises 25 to 30% by volume of the first emulsifier; 25 to 30% by volume of the second emulsifier and 25 to 50% by volume of the vegetable oil. Preferably both the concentrate and the final cleaner are free or substantially free of both an alcohol and mineral oil (e.g. less than 10% by volume). In one preferred embodiment the concentrate comprises less than 50% by volume of the combined amounts of first and second emulsifier. In another embodiment of the invention the combined amounts of these emulsifiers comprise up to 30% by volume and in yet another up to 20% by volume.

The first and second emulsifiers are characterized by having different HLB-values; an empirically derived number which represents a measure of the extent to which a given emulsifier is hydrophilic or lipophilic. In particular, the first emulsifier is chosen to have a relatively high HLB-value and the second emulsifier a relatively low HLB value (with respect to each other). In other words the HLB-value of the first emulsifier should be higher than that of the second emulsifier; for example by at least 0.5 suitably at least 1.0 HLB value units. Typically, the first emulsifier has an HLB-value in the range 10 to 17, most preferably in the range 12 to 16 whilst that of the second emulsifier is suitably in the range 5 to 12, most preferably in the range 6 to 12. An example of a preferred family of concentrates is one in which the first emulsifier has an HLB-value in the range 14 to 16 and the second emulsifier an HLB-value in the range 10 to 12. The emulsifiers used herein are preferably of the non-ionic or amphoteric type.

Suitably the first and second emulsifiers and the vegetable oils are chosen so that the associated Hansen Solubility Parameter distance D_{SP} of at least one of these components is less than 10, preferably less than 7 and most preferably less than 5. Preferably all three components exhibit this property. This parameter, which relates the solubility characteristics of the component to those of the hydrocarbon contaminant in terms of _{D}, ^{P}, and _{H}, respectively the dispersion, polar and hydrogen bonding components of the Hildebrand solubility parameter, is defined by the equation:

D_{SP}=[4(_{D}s−_{D}p)²+(_{P}s−_{P}p)²+(_{H}s−_{H}p)²]

in which the additional indicators s and p identify respectively the component and the hydrocarbon contaminant. The following table exemplifies illustrates how Dₛₚ varies when the hydrocarbon contaminant is bitumen or another heavy hydrocarbon.

| Emuslifer/Oil | D_{SP} | _{DS} | _{PS} | _{HS} |
|---|---|---|---|---|
| Bitumen | | 17.9 | 4.6 | 3.2 |
| Eutanol G | 6.9 | 16.1 | 3.8 | 9 |
| Tween 85 | 3.0 | 16.5 | 5.5 | 3.9 |
| Corn oil* | 3.3 | 16.3 | 5.2 | 3 |
| Tween 40 | 4.9 | 16 | 3.5 | 6.1 |
| Marlowet R40 | 17.8 | 15.4 | 9.2 | 19.6 |
| Serdet | 8.6 | 16.5 | 11.9 | 6.9 |
| Ethylan 1005 | 6.4 | 16.3 | 4.8 | 8.7 |
| Biosoft | 1.1 | 18.1 | 5.6 | 3.6 |
| Berol 185 | 4.4 | 16.3 | 5.8 | 5.9 |
| Lutensol TO7 | 5.7 | 16.3 | 3 | 7.7 |
| SAS 30 | 5.4 | 16.3 | 8.8 | 4.1 |
| Lutensol XP90 | 4.5 | 16.3 | 5.8 | 6.2 |
| Rewoteric | 9.9 | 16.3 | 9.8 | 11.0 |

*other vegetable oils have similar D_{SP} values

In another embodiment of the invention, each emulsifier and vegetable oil is chosen so that (1) both of its _{P}s and _{H}s values are less than 12, preferably less than 10, and/or that (2) that its _{D}s value is in the range 16 to 19, preferably in the range 16 to 18. Preferably each emulsifier and vegetable oil is chosen so that both its _{P}s and _{H}s values are less than 7 and its _{D}s value is in the range 16 to 18.

In one preferred embodiment of the invention the first emulsifier is a mono-ether which can be considered as being derived structurally from an alcohol and a mono-fatty acid ester of a polyalkylene, preferably a polyethylene, glycol. Especially suitable alcohols include polyhydric alcohols derived from sugars such as glycerol, sorbitan, mannitol, and xylitol as well as derivatives thereof such as sorbitan. Suitably the fatty acid is a C₁₃ to C₂₂ saturated or unsaturated aliphatic fatty acid preferably selected from the group consisting of palmitic acid, oleic acid, stearic acid, linoleic acid, linolenic acid and substituted derivatives thereof.

In another preferred embodiment of the invention the second emulsifier comprises a di- or tri-ether which can be considered as being derived structurally from a polyhydric alcohol (such as those and their derivatives described above) and the same or different mono-fatty acid esters of a polyalkylene, preferably a polyethylene, glycol. Suitably this fatty acid is also one or more C₁₃ to C₂₂ saturated or unsaturated aliphatic fatty acids preferably selected from the group consisting of palmitic acid, oleic acid, stearic acid, linoleic acid, linolenic acid and substituted derivatives thereof. A more preferred second emulsifier is one which is a tri-ether in accordance with the above derived from sorbitan and where the remaining hydroxyl group on the sorbitan is etherified with a polyalkylene, preferably a polyethylene, glycol.

By the term polyalkylene glycol is meant a polyethylene glycol or a glycol copolymer formed from oxyethylene and oxypropylene monomer units wherein the oxyethylene content of the polyalkylene glycol moiety is greater than or equal to 50 mole %. Preferably, the polyalkylene glycols moieties employed in these emulsifiers comprise on average 5 to 100, preferably 5 to 50 alkylene oxide units with the exact number and molar percentage of oxyethylene to oxypropylene units depending on the particular HLB-value required. Most preferred are polyethylene glycol moieties containing 5 to 50 ethylene oxide units.

Alternatively, the first and/or second emulsifier can be derived from a C₁₃ to C₂₂ saturated or unsaturated aliphatic alcohol or from a naturally occurring material such as castor oil (a triglyceride of ricinoleic acid, oleic acid and linoleic acid) soybean oil or palm oil each of which has been alkoxylated, preferably ethoxylated, at one or more of its free hydroxyl group to generate emulsifiers in the desired HLB-value ranges. In such molecules the average number of ethylene oxide units in the ethoxylated chain is typically in the range 5 to 100 preferably 5 to 50; again depending on the particular HLB-value required.

In a more preferred embodiment, the first emulsifier comprises preferably a mono-ether of sorbitan and a mono-ester of palmitic acid and a polyethylene glycol. In another preferred embodiment, the second emulsifier comprises preferably a tri-ether of sorbitan and a mono-ester of oleic acid and a polyethylene glycol. In yet another embodiment these two more preferred types of first and second emulsifier are employed in the same concentrate.

In yet another preferred embodiment the first emulsifier is an ethoxylate of castor oil

The vegetable oil used in the concentrate is suitably selected from the group consisting of corn oil, cottonseed oil, soybean oil, palm oil, rape seed oil, sunflower oil, and mixtures thereof. In one preferred embodiment the vegetable oil is corn oil alternatively known in the art as maize oil. Whilst it is most preferred to use the naturally occurring versions of these oils industrially synthesised versions thereof may also be employed. Preferably the concentrate does not contain any non-polar mineral oil.

The concentrate described above may further comprise additives well known in the art such dyes, anti-foams to improve performance and biocides and/or fungicides to increase shelf life.

The concentrates of this aspect of the present invention represent one efficient way of supplying the cleaner to the end user. Thus, it is, in general, contemplated that such concentrates will not normally be used as cleaners per se (although such a possibility remains and is within the scope of our invention). Rather, it is envisaged that they will be diluted in one or more stages to generate a final, dilute, aqueous cleaning solution. One way of affecting this is in two-stages by creating first an intermediate water-diluted pre-solution and thereafter an even more diluted cleaning solution. It will also be appreciated that each of the pre-solution and cleaner can be produced directly from the three components of the concentrate and water without having to go through all or indeed any of these dilution stages. Such direct production methods (together with the materials derived therefrom) are considered to fall within the scope of our patent application.

Thus, according to a second aspect of the invention there is provided a pre-solution comprising 10% to 20% of the concentrate and 80% to 90% of water.

When producing the pre-solution the concentrate is diluted, suitably emulsified, with warm or hot water preferably at a temperature from 50° C. to 100° C. and under conditions of high shear. Optionally, at this stage further additives mentioned above can be added if not already present in the concentrate. Thereafter, the pre-solution is further diluted with water to produce a cleaning solution whose composition suitably comprises from 50 to 500 volumes of water per unit volume of concentrate. Typically, such cleaning solutions comprises water and 0.05-1.2% vol/vol of the first emulsifier, 0.05-1.2% vol/vol of the second emulsifier and 0.1-1.4% vol/vol of the vegetable oil with cleaning solutions comprising water and 0.2-1.2% vol/vol of the first emulsifier 0.2-1.2% vol/vol of the second emulsifier and 0.4-1.4% vol/vol of the vegetable oil being preferred.

The cleaning solution is useful for the treatment of hydrocarbon-contaminated land on the one hand and for cleaning hydrocarbon contaminated surfaces such as the interior and exterior of vessels or pipes used to hold hydrocarbons on the other. When used in these ways, the hydrocarbon is liberated and caused to float on the surface of the water where it can be readily removed by decanting, siphoning, skimming and the like. The concentrate has the additional advantage that it is miscible in water without the addition of significant quantities of alcohol. Finally, the concentrate, pre-solution and the cleaning solution all have a high flashpoint (typically greater than 55° C.) making them especially suitable for use in controlled zones and easy to transport since they comply with non-hazardous transport regulations.

On an industrial scale, the cleaning solution can be conveniently applied to the fouled surfaces of a vessel using a conventional pressure washer or similar apparatus. If such a device is used it is envisaged that the cleaning solution can be generated in situ in the head of the washer by continuously dosing a pressurised stream of water from a delivery hose with concentrate and/or pre-solution maintained in one or more separate reservoirs. In this embodiment, the washer will suitably be provided with a mixing chamber immediately upstream of its outlet nozzles where the cleaning solution can be continuously created under conditions of high shear.

The present invention is now illustrated by reference to the following examples.

### EXAMPLE 1

A concentrate was produced by blending together in a stirred reactor the following components in the volume proportions (vol/vol) shown:
50.0% corn oil;
25.0% polyoxyethylene sorbitan monopalmitate (Tween 40®; non-ionic surfactant ex Croda International plc; HLB=15.6, (CAS 9005-66-7)) and 25.0% polyethylene glycol sorbitan trioleate (Tween 85®; non-ionic surfactant ex Croda International plc; HLB=11.0; (CAS 9005-70-3)).

Samples of the concentrate described above were then diluted with water (60-70° C.) in a 250 ml beaker on a stirrer hotplate to generate a cleaning solution comprising 1% by volume of the concentrate. A small galvanised steel test plate was then coated with heavy fuel oil before being immersed in the cleaning solution. Removal of the oil from the test plate was monitored by visually inspecting the contents of the beaker at ten minute intervals until removal was complete. At this stage the test plate was removed and washed with cold water and found not to be oily. For 0.17 g of oil on the test plate, it was found that the 1% solution effected complete cleaning within 30 minutes at the temperature mentioned above. After washing was completed, the two-phase liquid contents of the beaker (dark oily layer floating on a cloudy milky aqueous phase) were removed and separated by decanting. The recovered aqueous phase was found to be suitable for re-use, optionally after further concentrate has been added, or for discharge to a drain.

### EXAMPLE 2

A concentrate was produced by blending together in a stirred reactor the following components in the volume proportions (vol/vol) shown:
50.0% corn oil;
25.0% Rewoteric AM VSF® (capryl amphopropionate surfactant; ex Evonik Industries; HLB=c.14-15) and
25.0% polyethylene glycol sorbitan trioleate (Tween 85®; non-ionic surfactant ex Croda International plc; HLB=11.0; (CAS 9005-70-3)).

Samples of the concentrate described above were then diluted with water (60-70° C.) in a 250 ml beaker on a stirrer hotplate to generate a cleaning solution comprising 1% by volume of the concentrate. A small galvanised steel test plate was then coated with heavy fuel oil before being immersed in the cleaning solution. Removal of the oil from the test plate was monitored by visually inspecting the contents of the beaker at ten minute intervals until removal was complete. At this stage the test plate was removed and washed with cold water and found not to be oily. For 0.17 g of oil on the test plate, it was found that the 1% solution also effected complete cleaning within 30 minutes at the temperature mentioned above. After washing was completed, the two-phase liquid contents of the beaker (dark oily layer floating on a cloudy milky aqueous phase) were removed and separated by decanting. The recovered aqueous phase was found to be suitable for re-use, optionally after further concentrate has been added, or for discharge to a drain.

### EXAMPLE 3

Another concentrate was produced by blending together in a stirred reactor the following components in the volume proportions (vol/vol) shown:
40.0% corn oil;
30.0% Marlowet R40® (castor oil ethoxylate (40 EO) surfactant; ex Sasol Limited; HLB=c.15-16) and
30.0% Rewoteric AM VSF® (capryl amphopropionate surfactant; ex Evonik Industries; HLB=c.14-15).

A sample of this concentrate was then diluted with water (60-70° C.) in a 250 ml beaker on a stirrer hotplate to generate a cleaning solution comprising 1% by volume of the concentrate. Again a small galvanised steel test plate was then coated with heavy fuel oil before being immersed in the cleaning solution. Removal of the oil from the test plate was monitored by visually inspecting the contents of the beaker at ten minute intervals until removal was complete. At this stage the test plate was removed and washed with cold water and found not to be oily. In this case, it was found that the 1% solution effected complete cleaning only after 60 minutes at the temperature mentioned above. After washing was completed, the two-phase liquid contents of the beaker (dark oily layer on a less cloudy milky aqueous phase) were removed and separated by decanting. Thus this formulation was slightly inferior to that of Examples 1 and 2 where complete cleaning occurred in 30 minutes. The recovered aqueous phase was found to be suitable for re-use, optionally after further concentrate has been added, or for discharge to a drain.

The results from Examples 1 to 3 are summarised in the Table below:

| | | Conc. | HLB | Clean | DSP |
|---|---|---|---|---|---|
| Example | Component | % | value | after | Value |
| 1 | Corn-oil | 50 | | 30 mins | 3.3 |
| | Tween 85 | 25 | 11 | | 3 |
| | Tween 40 | 25 | 15.6 | | 4.9 |
| 2 | Corn-oil | 50 | | 30 mins | 3.3 |
| | Tween 85 | 25 | 11 | | 3 |
| | Rewoteric | 25 | 14-15 | | 9.9 |
| 3 | Corn-oil | 40 | | 60 mins | 3.3 |
| | Marlowet-R40 | 30 | 15-16 | | 17.8 |
| | Rewoteric | 30 | 14-15 | | 9.9 |

### EXAMPLES 4 TO 10

In these examples, formulations according to the present invention were compared with formulations derived from those used in Examples 55 to 58 in U.S. Pat. No. 5,780,487. Thin strips of oil measuring 1″×0.25″ were drawn down onto aluminium plates using the side of a small metal spatula. These test strips were then immersed in 0.5% aqueous solutions of the various formulations exemplified in the above-mentioned table at 60° C. and assessed visually over time for the % oil removed from the metal surface. The results were as follows:

| | Component w/w % | | | | | Formu- |
|---|---|---|---|---|---|---|
| | | | Soy- | White | D- | lation |
| | Tween | Tween | bean | mineral | limo- | appear- |
| Example | 40 | 85 | Oil | oil | nene | ance |
| 4 | 25 | 25 | 50 | 0 | 0 | Clear |
| 5 (Compar- | 25 | 25 | 0 | 50 | 0 | Hazy |
| ative) | | | | | | |
| 6 | 10 | 10 | 80 | 0 | 0 | Hazy |
| 7 (Compar- | 10 | 10 | 0 | 80 | 0 | Hazy |
| ative) | | | | | | |
| 8 (Compar- | 25 | 25 | 0 | 0 | 50 | Hazy |
| ative) | | | | | | |
| 9 | 15 | 15 | 70 | 0 | 0 | Hazy |
| 10 (Compar- | 15 | 15 | 0 | 70 | 0 | Hazy |
| ative) | | | | | | |

% Oil Removed

| | 1 | 5 | 10 | 15 |
|---|---|---|---|---|
| Example | minute | minutes | minutes | minutes |
| 4* | 10 | 45 | 50 | 55 |
| 5* | 20 | 35 | 40 | 60 |
| 6* | 7.5 | 40 | 45 | 50 |
| 7* | 5 | 5 | 7.5 | 15 |
| 8 | 50 | 60 | 70 | 70 |
| 9* | 10 | 40 | 50 | 55 |
| 10* | 5 | 5 | 7.5 | 10 |

In this table the asterisk denotes an averaging of multiple tests.

From Examples 4, 5 and 8 it is apparent that, at a high total emulsifier concentration, the cleaning properties of formulations containing soybean oil, white mineral oil and d-limonene are similar. Example 1 demonstrates that compositions containing vegetable oil exhibit the desirable phase-separation after use which confers desirable environmental benefits.

Furthermore at total emulsifier concentrations of less than 50%, for example 20% and 30%, formulations using vegetable oils exhibited superior cleaning properties compared to the prior art mineral oil formulations (Examples 6 v 7 and Examples 9 v 10).

1. A concentrate for manufacturing an aqueous cleaning solution for treating hydrocarbon-contaminated soil and/or for cleaning hydrocarbon-contaminated surfaces comprising:
(i) 10-60% by volume of a first emulsifier comprising a non-ionic surfactant having an HLB value in the range 12 to 16;
(ii) 10-60% by volume of a second emulsifier comprising a non-ionic surfactant having an HLB value in the range 6 to 12; and
(iii) 20-70% by volume of vegetable oil.

2. A concentrate for manufacturing an aqueous cleaning solution for treating hydrocarbon-contaminated soil and for cleaning hydrocarbon-contaminated surfaces, wherein the concentrate is made by mixing together:
(i) 10-60% by volume of a first emulsifier comprising a non-ionic surfactant having an HLB value in the range 12 to 16;
(ii) 10-60% by volume of a second emulsifier comprising a non-ionic surfactant having an HLB value in the range 6 to 12; and
(iii) 20-70% by volume of vegetable oil.

3. A concentrate for manufacturing an aqueous cleaning solution for treating hydrocarbon-contaminated soil and for cleaning hydrocarbon-contaminated surfaces according to claim 1 comprising:
(i) 25 to 30% by volume of a first emulsifier comprising a non-ionic surfactant having an HLB value in the range 12 to 16;
(ii) 25 to 30% by volume of a second emulsifier comprising a non-ionic surfactant having an HLB value in the range 6 to 12; and
(iii) 25 to 50% by volume of vegetable oil.

4. The concentrate according to claim 1, wherein the total amount of the first and second emulsifiers is less than 30% by volume.

5. The concentrate according to claim 1, wherein the associated Hansen Solubility Parameter distance D_{SP} of at least one of the first and second emulsifiers and the vegetable oil is less than 7.

6-7. (canceled)

8. The concentrate according to claim 1, wherein the first emulsifier is a non-ionic surfactant with an HLB-value of from 14 to 16 and the second emulsifier is a non-ionic surfactant with an HLB-value from 10 to 12.

9. The concentrate according to claim 1, wherein the first emulsifier comprises a mono-ether of sorbitan and a mono-fatty acid ester of a polyethylene glycol.

10. The concentrate according to claim 9 wherein the fatty acid is selected from the group consisting of: palmitic acid, oleic acid, stearic acid, linoleic acid and substituted derivatives thereof.

11. The concentrate according to claim 10 wherein the first emulsifier comprises mono-ether of sorbitan and a mono-ester of palmitic acid and a polyethylene glycol.

12. The concentrate according to claim 1, wherein the second emulsifier comprises a di- or tri-ether of sorbitan and a mono-fatty acid ester of a polyethylene glycol.

13. The concentrate according to claim 12 wherein the fatty acid is selected from the group consisting of: palmitic acid, oleic acid, stearic acid, linoleic acid and substituted derivatives thereof.

14. The concentrate according to claim 12 wherein the second emulsifier comprises a di- or tri-ether of sorbitan and a mono-ester of oleic acid and a polyethylene glycol.

15. The concentrate according to claim 14 wherein the second emulsifier is a tri-ester where the remaining hydroxyl group on the sorbitan is etherified with a polyethylene glycol.

16. The concentrate according to claim 1, wherein the vegetable oil is selected from the group consisting of: corn oil, cottonseed oil, soya oil, palm oil, rape seed oil, sunflower oil and mixtures thereof.

17. A pre-solution for manufacturing an aqueous cleaning solution comprising a composition equivalent to that derived by mixing together 10% to 20% of a concentrate according to claim 1 and 80% to 90% of water.

18. An aqueous cleaning solution for treating hydrocarbon contaminated land or for cleaning hydrocarbon contaminated surfaces comprising water, 0.05-1.2% vol/vol of a first emulsifier, 0.05-1.2% vol/vol of a second emulsifier and 0.1-1.4% vol/vol of a vegetable oil.

19. An aqueous cleaning solution for treating hydrocarbon contaminated land or for cleaning hydrocarbon contaminated surfaces made by mixing together directly or indirectly water, 0.05-1.2% vol/vol of a first emulsifier comprising a non-ionic surfactant having an HLB value in the range 12 to 16, 0.05-1.2 vol % of a second emulsifier comprising a non-ionic surfactant having an HLB value in the range 6 to 12 and 0.1-1.4% vol/vol of a vegetable oil.

20. An aqueous cleaning solution according to claim 18 comprising water, 0.2-1.2% vol/vol of a first emulsifier comprising a non-ionic surfactant having an HLB value in the range 12 to 16, 0.2-1.2% vol/vol of a second emulsifier comprising a non-ionic surfactant having an HLB value in the range 6 to 12 and 0.4-1.4% vol/vol of a vegetable oil.

21. An aqueous cleaning solution according to claim 18 manufactured from a pre-solution which in turn has been manufactured from a concentrate comprising:
(i) 10-60% by volume of a first emulsifier comprising a non-ionic surfactant having an HLB value in the range 12 to 16;
(ii) 10-60% by volume of a second emulsifier comprising a non-ionic surfactant having an HLB value in the range 6 to 12; and
(iii) 20-70% by volume of vegetable oil.

22. A method for treating a hydrocarbon-contaminated soil and/or for cleaning a hydrocarbon-contaminated surface, comprising contacting the hydrocarbon-contaminated soil and/or the hydrocarbon-contaminated surface with the concentrate of claim 1.
